(19) United States
(12) Patent Application Publication
(10) Pub. No.: US 2024/0416487 A1
(43) Pub. Date: Dec. 19, 2024

(54) GRASPING TOOL

(71) Applicant: William Henry Brandt, Glendale, CA (US)

(72) Inventor: William Henry Brandt, Glendale, CA (US)

(21) Appl. No.: 18/661,504

(22) Filed: May 10, 2024

Related U.S. Application Data
(60) Provisional application No. 63/508,158, filed on Jun. 14, 2023.

(51) Int. Cl. B25B 7/02

(52) U.S. Cl. CPC B25B 7/02

(57) ABSTRACT

A grasping tool for use in electrical work includes handles for a user to hold the grasping tool, a hinge joint connecting the handles, and at least one first bident and at least one second bident connected to the hinge joint at a side of the grasping tool opposite the handles, the first bident and second bident facing each other to hold electrical wires therebetween.

### CROSS-REFERENCE TO RELATED APPLICATION

The present application claims the benefit of U.S. Provisional Application Ser. No. 63/508,158, filed on Jun. 14, 2023, the entire content of which is hereby incorporated by reference.

### BACKGROUND

### 1. Field

Embodiments of the present disclosure relate to a grasping tool for use during electrical work. For example, a grasping tool for grasping wires while twisting and/or connecting wires together during electrical work.

### 2. Description of the Related Art

In working with electrical wiring, it can be necessary to connect two or more wires together so that electrical current can travel through the connection from one wire to the other(s). One way in the art to connect wires is to twist them together using, for example, lineman pliers.

Some electricians or others doing electrical work hold the wires together with one hand and use the other hand to twist with the wires together using pliers. However, this can be difficult to do in tight spaces, as it can be difficult to get an adequate grasp on the wires in tight areas, like crawlspaces, attics, junction boxes, and other enclosed or hard to access areas in which wiring/rewiring may be needed.

Connecting wiring may also be made more difficult due to the fact that the wires used in residential and commercial properties are generally low gauge wires, such as 12- and 14-gauge wires, with thicker diameters that can be difficult to twist together. In some instances, the outer wires can spiral around the inner wires, instead of all the wires twisting together evenly. Such twists and other loose or inadequate twists can lead to electricity arcing across the wired connection, releasing heat, and potentially leading to electrical fires.

The above information disclosed in this Background section is only for enhancing the understanding the background of the present disclosure, and therefore, it may contain information that does not form the prior art that is already known in this country to a person of ordinary skill in the art.

### SUMMARY

Aspects of one or more embodiments of the present disclosure are directed to a grasping tool for grasping electrical wires.

Aspects of one or more embodiments of the present disclosure are directed to a method for grasping electrical wires using a grasping tool.

Additional aspects will be set forth in part in the description which follows and, in part, will be apparent from the description, or may be learned by practice of the presented embodiments of the disclosure.

In one or more embodiments, a grasping tool for use in electrical work includes handles for a user to hold the grasping tool, a hinge joint connecting the handles, and at least one first bident and at least one second bident connected to the hinge joint at a side of the tool opposite the handles, the first bident and second bident facing each other to hold electrical wires therebetween.

### BRIEF DESCRIPTION OF THE DRAWINGS

FIG. 1 is a perspective view of a grasping tool, according to one or more embodiments of the present disclosure.

FIG. 2 is an angled view from above of the grasping tool in a fully closed position, according to one or more embodiments of the present disclosure.

FIG. 3 is an angled view from above of the grasping tool in a fully open position, according to one or more embodiments of the present disclosure.

FIG. 4 is a side view of the grasping tool, according to one or more embodiments of the present disclosure.

FIG. 5 is an end view of the grasping tool in a partially closed position, according to one or more embodiments of the present disclosure.

FIG. 6 is perspective view of the grasping tool in use, according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

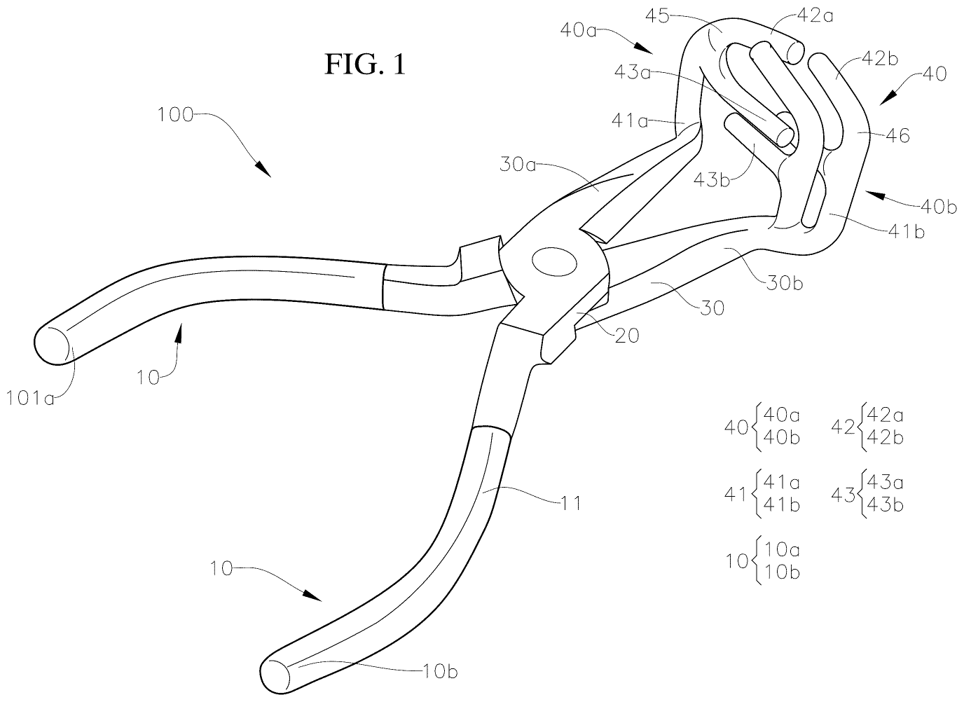

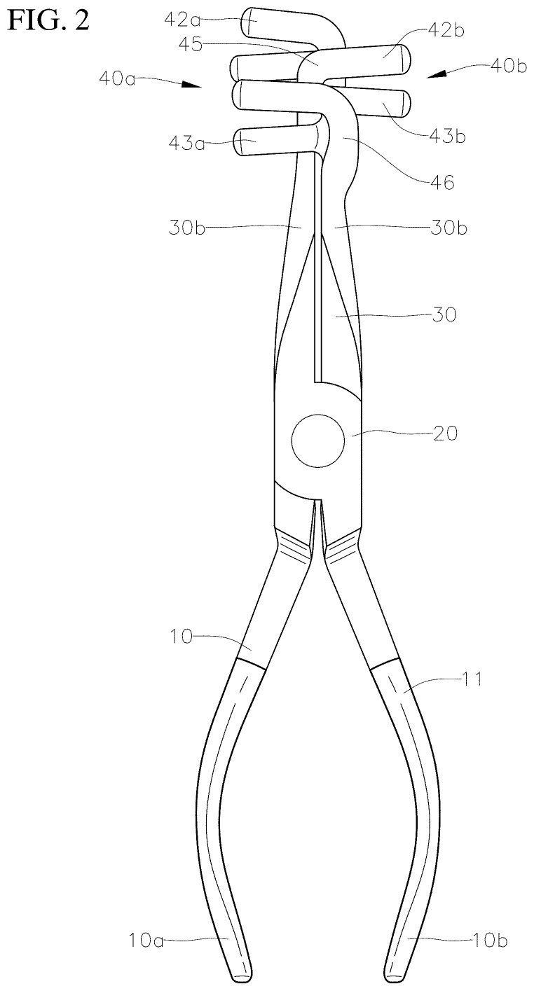

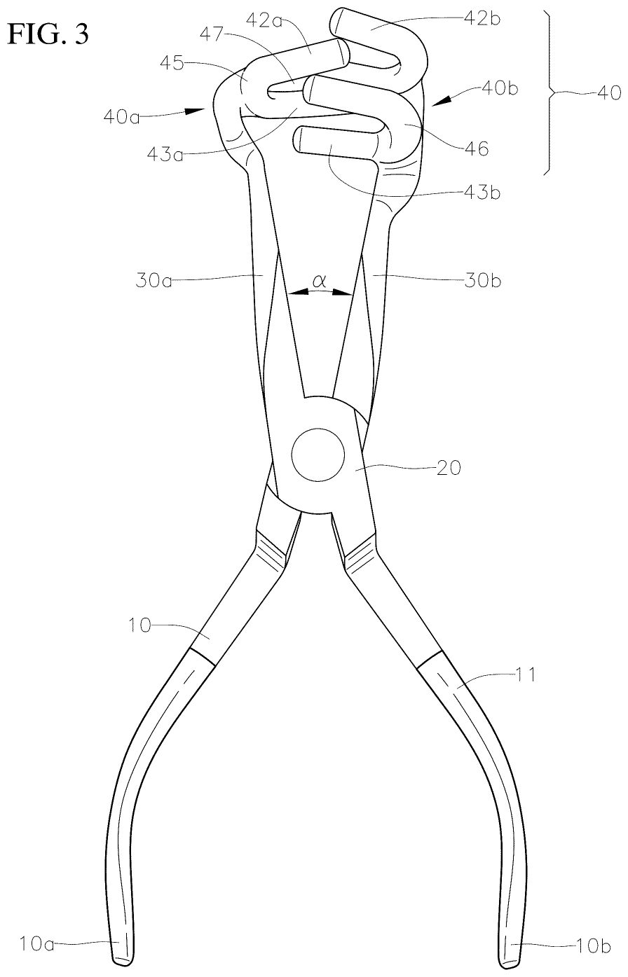

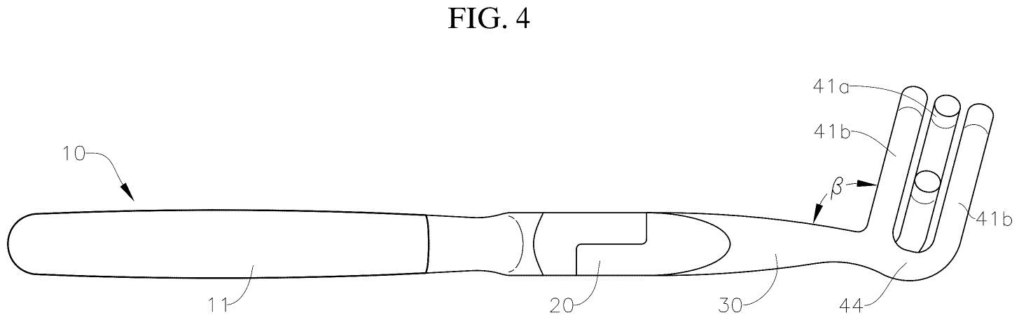

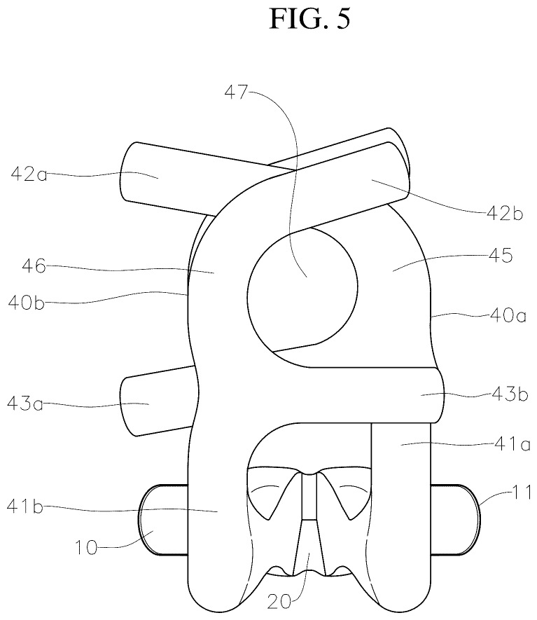

FIG. 1 is a perspective view of a grasping tool according to one or more embodiments of the present disclosure. FIG. 2 is a view from above of the grasping tool in a fully closed position, according to one or more embodiments of the present disclosure. FIG. 3 is a view from above of the grasping tool in a fully open position, according to one or more embodiments of the present disclosure. FIGS. 2 and 3 are slightly angled (in a direction toward the handle) from a top view to better view a prong portion 40 of the grasping tool 100. FIG. 4 is a side view of the grasping tool, according to one or more embodiments of the present disclosure. FIG. 5 is an end view of the grasping tool in a partially closed position, according to one or more embodiments of the present disclosure.

The grasping tool 100 includes a handle portion 10, a hinge joint 20, an extension portion 30 and a prong portion 40. The grasping tool 100 may be made out of a steel alloy, such as a carbon steel. The steel alloy may include additives such as vanadium or chromium, to improve strength and prevent corrosion. However, the present disclosure is not limited thereto and the grasping tool 100 may be made out of any metal or other material suitable in the art.

The handle portion 10 may include two handles 10a, 10b that may be held by an electrician or other person using the grasping tool 100 for electrical work (hereinafter, the “user”). The handles 10a, 10b may include a nonconductive insulation 11 covering the handles 10a, 10b to prevent or reduce the chance of electric shock. This insulation 11 may be a plastic coating and/or may also act as a grip to help reduce or prevent slippage of the tool 100 during use. However, the present disclosure is not limited thereto and embodiments may not include the insulation 11.

The hinge joint 20 may connect the two handles 10a, 10b of the handle portion 10. The hinge joint 20 may be a pivot point about which the handles 10a, 10b and extension portion 30 rotate. For example, the first handle 10a of the handle portion 10 may be connected to (e.g., may be integral with) a second extension part 30b on the opposite side of the tool 30 from the first handle 10a in a plan view (see, e.g., FIGS. 2 and 3). The second handle 10b may be connected to (e.g., may be integral with) a first extension part 30a on the opposite side of the tool 30 from the second handle 10b in a plan view (see, e.g., FIGS. 2 and 3). The hinge joint 20 may be a pivot point in between the handle portion 10 and the extension portion 30 and may allow the first handle 10a and second extension part 30b to rotate relative to the second handle 10b and the first extension part 30a. When the user compresses the two handles 10a, 10b together, the first and second extension parts 30a, 30b will also compress closer together. When the user pulls the two handles 10a, 10b apart, the first and second extension portions 30a, 30b will also be pulled apart.

While the hinge joint 20 shown in FIG. 1 has a lap joint construction, the present disclosure is not limited to such a construction. Any joint suitable in the art may be used, such as a box joint, etc.

The extension portion 30 includes the first and second extension parts 30a, 30b. The extension portion 30 connects the hinge joint 20 and handles 10 to the prong portion 40. The extension portion 30 provides length to the tool 100 to allow the tool to reach into tight areas and to increase the distance between the right and left sides of the prong portion 40 (i.e., the distance between first prong part 40a and the second prong parts 40b) even when the angle α of the opening between the first and second extension parts 30a, 30b is small (see, e.g., FIG. 3). By including the extension portion 30, the tool 100 may only open to a small or acute angle and still have sufficient space between the first and second prong parts 40a, 40b for the wires to be placed between the prong portions 40a, 40b, allowing the tool to work in small or narrow areas. For example, the angle α may be at most 40° or less, 35° or less, 30° or less, or 25° or less. In other words, the tool 100 may only open to an angle α of (e.g., may have a maximum opening angle of) 40° or less, 35° or less, 30° or less, or 25° or less. However, the present disclosure is not limited thereto and the tool may open to an angle greater than 40°.

The tool 100 also includes the prong portion 40. The prong portion 40 includes at least one first prong part 40a connected to (e.g., integral with) the first extension part 40a and at least one second prong part 40b connected to (e.g., integral with) the second extension part 30b. In FIG. 1, one first prong part 40a and two second prong parts 40b are shown. However, the present disclosure is not limited thereto. In one or more embodiments, there may be only one first prong part 40a and only one second prong part 40b. In one or more embodiments, there may be two first prong parts 40a and only one second prong part 40b. In one or more embodiments, there may be two or more first prong parts 40a and two or more second prong parts 40b. The first and second prong parts 40a, 40b may alternate, so that a first prong part 40a is followed by a second prong 40b and/or vice versa in a longitudinal direction of the tool 100 (i.e., a direction from the handle 10 toward the prong portion 40 of the tool 100). In one or more embodiments, the number of first prong parts 40a may be the same as the number of second prong parts 40b or may differ from the number of second prong parts 40b by one (e.g., if there are two first prong parts 40a, there may be one second prong part 40b or there may be three second prong parts 40b) so that the first and second prong parts 40a, 40b can alternate.

The prong portion 40 may also include a straight portion 41, and prongs 42, 43. The straight portion 41 may include at least one first straight part 41a as part of the first prong part 40a and at least one second straight part 41b as part of the second prong part 40b. The first straight part (or parts) 41a are connected to (e.g., integral with) the first extension part 30a and the second straight part (or parts) 40b are connected to (e.g., integral with) the second extension part 30b. For example, in FIG. 1, there is one first straight part 41a that is connected to (e.g., integral with) the first extension part 30a and there are two second straight parts 41b that are each connected to (e.g., integral with) the second extension part 30b. However, the present disclosure is not limited thereto. In one or more embodiments, there are one or more first straight parts 41a and one or more second straight parts 41b or the straight parts 41a, 41b may not be included.

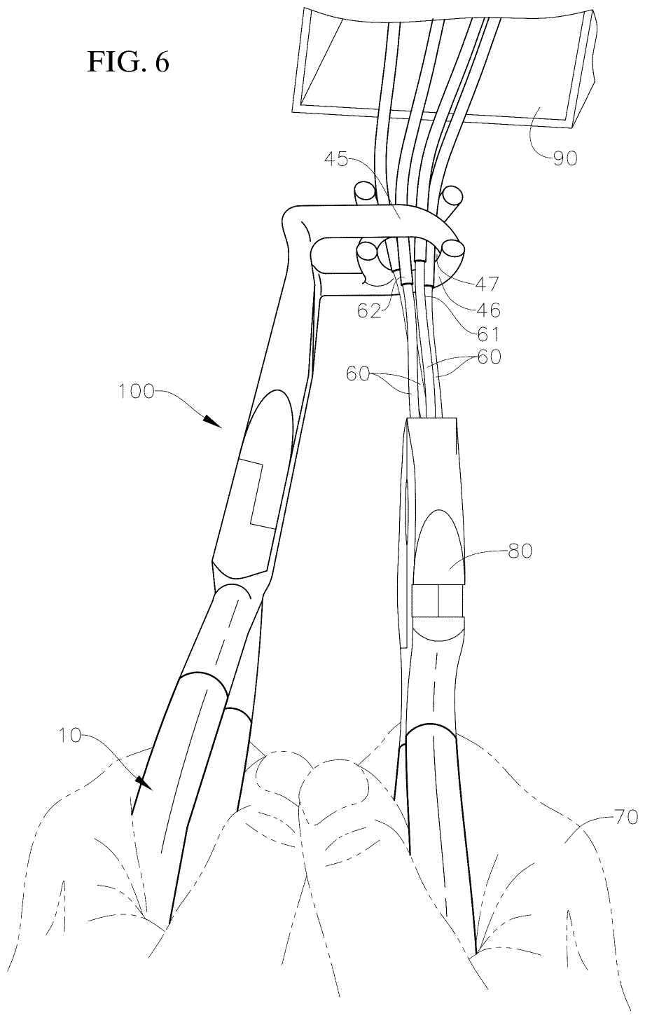

The straight portion 41 may have an angle β of 90° or more relative to the extension portion 30 (see, e.g., FIG. 4). For example, the angle β may be equal to or greater than 90° and may be equal to or less than 110°. The angle β may be from about 90° to about 120°, from about 90° to about 110°, from about 90° to about 105°, or 90° to about 100°. The angle β may be more than about 90° and equal to or less than about 120°, more than about 90° and equal to or less than about 110°, more than about 90° and equal to or less than about 105°, or more than about 90° and equal to or less than about 100°. In the above ranges, the angle β between the extension portion 30 and the straight portion 41 may allow the user to use pliers, such as lineman pliers, in front of the tool 100 (e.g., above the tool 100 in FIG. 4 or adjacent the tool 100, as shown, for example, in FIG. 6) to twist wires while the wires are being held with the grasping tool. For example, by having an angle β greater than 90°, the user has additional space to use pliers to twist electrical wires in front of or adjacent to the grasping tool and while using the grasping tool.

In embodiments in which there are two or more first prong parts 40a or two or more second prong parts 40b, there may be a connection part 44 between adjacent first prong parts 40a or second prong parts 40b, respectively. For example, as shown in FIG. 4, there is a connection part 44 between adjacent second prong parts 40b. The connection part 44 may be substantially straight or may be curved upwards towards the adjacent second prong parts 40b, creating a substantially “U” shape with the adjacent second prong parts 40b.

The connection part 44 may connect the second prong parts 40b such that there is sufficient space between the adjacent second prong parts 40b such that the first prong part 40a may fit between the two adjacent second prong parts 40b. For example, the length of the connection part 44 may be greater than the width of the first prong part 40a so that the first prong part 40a can fully fit between the adjacent second prong parts 40b when the tool 100 is closed and so that the first prong part 40a and the second prong parts 40b can slide past each other when the tool is opened and not prevent the tool from opening as necessary for the tool 100 to function.

In embodiments in which hinge joint 20 is a pivot point, the first prong parts 40a and the second prong parts 40b will not travel fully laterally relative to each other when the tool 100 is being opened, but will travel in a slight circular direction due to the pivot point. In such embodiments, the distance between the first prong part 40a and the second prong parts 40b (i.e., the length of the connection part 44) may be sufficient to accommodate the angle of the prongs 42, 43 as they travel in the slight circular direction. For example, the length of the connection part 44 may be about 1.5 to two times the width of the first prong part 40a. In addition, in one or more embodiments, the first prong part 40a may be centered between the second prong parts 40b or offset towards the farthest of the second prong parts 40b along the longitudinal direction of the tool 100.

The prong portion 40 includes upper prongs 42 and lower prongs 43. The upper prongs 42 are at the top portion of the prong portion 40 and the lower prongs 43 are at the bottom of the prong portion 40. The prongs 42 and 43 are connected to (e.g., integral with) each other. In one or more embodiments, the prongs 42 and 43 together form a generally open “U” (or inverse parabolic) shape that is rotated 90° to face horizontally. However, the shape is not limited thereto, and may be any suitable open shape capable of holding wires, such as a “V” shape, etc.

The prongs 42 may include at least one first upper prong 42a as part of the first prong part 40a and at least one second upper prong 42b as part of the second prong part 40b. The first upper prong (or prongs) 42a are connected to (e.g., integral with) the first straight part (or parts) 41a and thus also connected to (e.g., integral with) the first extension part 30a. The second upper prong (or prongs) 42b are connected to (e.g., integral with) the second straight part (or parts) 41b and thus also connected to (e.g., integral with) the second extension part 30b. For example, in FIG. 1, there is one first upper prong 42a that is connected to (e.g., integral with) the first straight part 41a and there are two second upper prongs 42b that are each connected to (e.g., integral with) with the second straight part 41b. However, the present disclosure is not limited thereto. In one or more embodiments, there may be one or more first upper prongs 42a and one or more second upper prongs 42b.

The prongs 43 may include at least one first lower prong 43a as part of the first prong part 40a and at least one second lower prong 43b as part of the second prong part 40b. The first lower prong (or prongs) 43a are connected to (e.g., integral with) the first straight part (or parts) 41a and thus also connected to (e.g., integral with) the first extension part 30a. The second lower prong (or prongs) 43b are connected to (e.g., integral with) the second straight part (or parts) 41b and thus also connected to (e.g., integral with) the second extension part 30b. For example, in FIG. 1, there is one first lower prong part 43a that is connected to (e.g., integral with) the first straight part 41a and there are two second lower prongs 43b that are each connected to (e.g., integral with) with the second straight part 41b. However, the present disclosure is not limited thereto. In one or more embodiments, there may be one or more first lower prongs 43a and one or more second lower prongs 43b.

The first upper prong 42a and first lower prong 43a are connected to (e.g., integral with) each other to form a first bident 45. The first upper prong 42a and first lower prong 43a together (i.e., the first bident 45) form a generally open “U” shape that is rotated 90° to face horizontally (e.g., an inverse parabolic shape). However, the shape is not limited thereto, and may be any suitable open shape capable of holding wires, such as a “V” shape, etc. Each of the second upper prongs 42b are connected to (e.g., integral with) a respective one of the second lower prongs 43b to form a second bident 46. Each pair of one second upper prong 42b and one second lower prong 43b (i.e., the second bident 46) form a generally open “U” shape that is rotated 90° to face horizontally (e.g., an inverse parabolic shape). However, the shape is not limited thereto, and may be any suitable open shape capable of holding wires, such as a “V” shape, etc.

The first bident 45 and the second bidents 46 face each other. In other words, the open end of the first bident 45 faces the open ends of the second bidents 46. Wires can be placed or pulled into the opening 47 formed between the first and second bidents 45, 46.

FIG. 6 is perspective view of the grasping tool in use, according to one or more embodiments of the present disclosure. In use, the opening 47 between the first and second bidents 45, 46 of the tool 100 is inserted over two or more wires 60, or the wires 60 are pulled through the opening 47 between the first and second bidents 45, 46. In some embodiments, the wires 60 may extend out of a junction box 90. The wires 60 may be pulled through so that exposed ends 61 of the wires overlap each other, so that electricity can travel between the wires once they are connected. The wires 60 may be pulled through the opening 47 until insulated portions 62 of the wires overlap the first and second bidents 45, 46. The user 70 can then compress the handles 10 until the wires 60 are firmly secured (e.g., securely held) in between the first and second bidents 45, 46 of the tool 100. The user 70 may then use pliers 80 (such as lineman pliers) to twist the wires 60 together to electrically connect them. Once the wires are twisted, a wire nut may be installed over the twist to secure the wires.

Because of the angle β between the prong portion 40 and extension portion (as shown, e.g., in FIG. 4), the user 70 may have additional space in front of the tool 100 to use the pliers 80 to twist the electrical wires 60. Further, the tool 100 allows the user 70 to hold the wires 60 in place so that the wires 60 can all be evenly twisted together, helping to avoid or reduce the incident of some wires simply twisting around a more central wire of the wire to be connected. Further, the grasping tool 100 is compact and allows wires to be firmly and/or tightly held together in tight spaces, where manually holding wires together with hands can be difficult.

The tool 100 may also include a protrusion or other means on the hinge joint to limit the angle α to which the tool 100 can open. By limiting the angle, the tool can be limited so that the open ends of the first and second bidents 45, 46 always overlap, so that the tool cannot accidentally open so far that the wires fall out from between the first and second bidents 45, 46. This also prevents the tool from opening too far in a narrow or limited access area, to prevent accidentally contacting areas outside of a target area.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region or section from another element, component, region, layer or section. Thus, a first element, component, region or section described below could be termed a second element, component, region or section, without departing from the spirit and scope of the present disclosure.

Spatially relative terms, such as “upper,” “lower,” “above,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. The device may be otherwise oriented (e.g., rotated 90 degrees or at other orientations) and the spatially relative descriptors used herein should be interpreted accordingly.

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “About”, “substantially,” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

As used herein, the singular forms “a”, “an” and “the” are intended to include the plural forms as well, unless the context clearly indicates otherwise.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. A grasping tool for use in electrical work, the grasping tool comprising:
handles to hold the grasping tool,
a hinge joint connecting the handles, and
at least one first bident and at least one second bident connected to the hinge joint at a side of the grasping tool opposite the handles, the first bident and the second bident facing each other to hold electrical wires therebetween.

2. The grasping tool of claim 1, further comprising an extension portion between the hinge joint and the first and second bidents, the extension portion having a first extension part connected to the first bident and a second extension part connected to the second bident.

3. The grasping tool of claim 2, wherein the first extension part and the second extension part are rotatable relative to each other at the hinge joint and a maximum opening angle between the first extension part and the second extension part is 40° or less.

4. The grasping tool of claim 2, wherein the first bident has an angle of about 90° to about 120° relative to the first extension part.

5. The grasping tool of claim 2, further comprising a third bident connected to the second extension part.

6. The grasping tool of claim 5, further comprising a connection part between the second bident and the third bident, the connection part having a length greater than a width of the first bident so that the first bident is capable of fitting between the second bident and the third bident when the grasping tool is closed.

7. The grasping tool of claim 1, wherein the first bident and the second bident each have a generally “U” shape.

8. A method of grasping wires using the grasping tool of claim 1, the method comprising:
grasping wires with the grasping tool; and
twisting wires together using pliers or another tool for twisting.

9. The method of claim 8, wherein the grasping of the wires further comprises inserting the wires between the first bident and the second bident.

10. The method of claim 8, wherein the grasping of the wires further comprises pulling the wires through an opening between the first bident and the second bident until insulated portions of the wires overlap the first bident and the second bident.

11. The method of claim 10, wherein the grasping of the wires further comprises compressing the handles until the wires are secured between the first bident and the second bident.

12. The method of claim 8, further comprising installing a wire nut over the twisted wires.
